(19) United States
(12) Patent Application Publication
(10) Pub. No.: US 2004/0195853 A1
(43) Pub. Date: Oct. 7, 2004

(54) Lifting and moving system

(76) Inventor: George Thomas Usher, Corinth, TX (US)

Correspondence Address: George Usher, 1707 Villa Court, Corinth, TX, 76210, US

(21) Appl. No.: 10/789,541

(22) Filed: Feb. 27, 2004

Related U.S. Application Data
(60) Provisional application No. 60/451,168, filed on Feb. 28, 2003.

(51) Int. Cl. B66F 1/00

(52) U.S. Cl. 294/153

(57) ABSTRACT

Disclosed herein is my invention of a Lifting and Moving Systems, typically used to lift and move large objects that can be of a various size, shape, geometry, material strength, weight, configuration and distribution of weight. My invention secures to the lifted article and is designed so the user is easily able to apply a lifting as well as a stabilizing force to the lifted article. The preferred embodiment of my invention consists of a series of connected handle assemblies and straps. The invention is easily put in use, adding little to the weight lifted, allows the user to apply a lifting and stabilizing force through proper lifting techniques without undue physical stress or strain. Following use, the invention is easily detached from the moved article and stored in a minimum of space.

### CROSS REFERENCE TO RELATED APPLICATIONS

This application claims the benefit of Provisional Application Serial #60/451,168 filed Feb. 28, 2003.

### STATEMENT REGARDING FEDERALLY SPONSERED RESEARCH OR DEVELOPMENT

Not applicable

### REFERENCE TO SEQUENCE LISTING, A TABLE OR A COMPUTER PROGRAM LISTING COMPACT DISK APPENDIX

Not Applicable

### BACKGROUND

1. FIELD OF THE INVENTION

This invention relates to devices used to lift and then relocate large, bulky and/or heavy articles, such as boxes, crates, furniture, large appliances, televisions and the like. More particularly, this invention relates to such devices that contain a means to fasten securely to the article being lifted and/or carried, and that are intended to be operated manually.

2. DESCRIPTION OF PRIOR ART

It is not at all uncommon today that people have a need to lift and move items that are large, bulky and/or heavy. Examples of such items in a typical dwelling include couches, chairs, televisions, refrigerators, boxes, mattresses, box springs, dressers, chests, mirrors and other furniture items. Common situations that require the lifting and moving of such articles include a young adult moving to their first apartment, or a family relocating to a different house, or receiving such an article following its purchase. Examples can be found in industry as well, such as movement of inventory at a retail bedding store, or typical activity at a warehouse for storage of large appliances.

The United States Patent and Trademark Office Classification scheme reserves several class/subclass combinations for such devices. Prior art exists describing numerous such devices with claims that address the issue of lifting large, bulky and otherwise unwieldy articles. Even so, room for improvement exists in the usability, functionality, performance, safety and convenience of such designs over and beyond what prior art teaches.

Example of such prior art include Frederickson, U.S. Pat. No. 6,186,566 that describes a lifting device with a horizontal surface that is meant to slide under the edge of an article to lift it, and a handle connected to this horizontal surface by a single upright support. Frederickson continues to describe a means whereby the lifted article can be loosely secured to the invention. The invention as claimed does not offer the flexibility of use on articles with irregular bottom surfaces or edges such as exists on furniture with legs and some large appliances. Neither does the design as claimed provide support of a lifted article that has insufficient strength along its edge, such as exists with large appliances. Frederickson's design provides for only a single lift point through which the user applies a vertical lifting force when using the invention. This aligns with the center of the invention. However, large objects may frequently have a center of gravity that is not close to its dimensional center, such as in the case of a television, where-in the majority of weight comes from the glass viewing screen, and thus the center of gravity is shifted very near the front edge of the television. Fredrickson's design would not allow the user to apply a stabilizing force to an object whose center of gravity was located significantly different from its geometric center. Neither does Frederickson supply a means to securely attach multiple devices—one to the other—for use by several individuals in the lifting of a heavy article.

Ybanez, in U.S. Pat. No. 6,193,293 B1 describes a lifting apparatus for box shaped cargo, and again fails to provide the flexibility of multiple grab points where-in the user can apply and maintain force not only to lift vertically, but to stabilize the upright orientation of the lifted article.

Hostetter, in U.S. Pat. No. 5,863,056 discloses a system to move mattresses and the like. His device, while including support webbing that can be repositioned along the long axis of the mattress, does not include flexibility in location of lift points where the user would grab to apply vertical force. As such, the user has also to apply a force to prevent the mattress from toppling over.

Pittman discloses in U.S. Pat. No. 6,309,000 a device to lift and carry articles of various thicknesses, but does not provide a means to secure the carried article to the lifting/carrying means, nor does he provide for lift points separated a distance to easily provide stability.

Caton, U.S. Pat. No. 2,399,786, Danboise, U.S. Pat. No. 4,953,904 and Johnson, U.S. Pat. No. 4,968,049 describe mattress carriers, without the pretense of being able to carry other large or bulky articles of varying geometry.

Brutlag, U.S. Pat. No. 4,119,250 and Staats, U.S. Pat. No. 5,102,178 claim devices again primarily for the lifting and carrying of mattresses and bedsprings. Like others described above, they too lack the separated grip points for a stabilizing application of forces, as well as the securing of the lifted article to the lifting means.

Sparling, U.S. Pat. No. 4,153,285 discloses a complex arrangement of clamps and springs in his lifting device, but requires that the lifted device be raised a substantial amount in order to get his device underneath it, does not provide for means to secure the load to the device and does not provide for stabilizing of the load via grips spread a distance apart.

### OBJECTS AND ADVANTAGES

The several objects and advantages of my invention present a device that is convenient in use, simple in design and manufacture, safe in operation and functional in purpose. Specifically, my invention presents a lifting apparatus that can be secured to the lifted article so as to essentially be considered a part of the lifted article. Such a configuration provides great ease and flexibility in the lifting and movement of the lifted article. The user is able to accommodate a variety of required movements of the lifted article as they traverse from one location to another, regardless of changes in width or direction of pathway, traversing around corners of hallways, lifting into/out of trailers or pickups, climbing or descending stairways or getting around obstacles in the path. There is no movement between the lifting device and the lifted article as the article is shifted, twisted, tilted and turned as required in transit. Thus the user easily maintains control during the lifting and moving operation.

My invention is designed with a substantial separation between points the user would hold and apply forces. This separation allows for a stabilizing effect on the lifted article. Loads with a center of gravity substantially different than their geometric center can be safely accommodated as my invention will allow attachment at the most convenient position given the geometry of the object. Even if the most convenient attachment point is not aligned with the center of gravity, the user is able to counteract the overturning tendency by applying compensating overturning forces because of the separation in the points they are able to grab the invention, and thus apply appropriate forces to the lifted article. This ability to provide a stabilizing force is also critical during transportation of the lifted article, as the center of gravity may shift due to a change in forces applied by one or more of the persons lifting, a change in height on one or more sides of the article such as when carrying the article up or down a stairway, or even the shifting of objects located within the object being carried such as items shifting inside a large box, crate or container.

This ability to not only lift but also stabilize what is being carried increases the safety of those lifting and carrying, and lessens the chance of damage occurring to the object or to surrounding objects. With the ability to easily compensate lifting forces as required in the above described situations, the user is far less likely to overstress themselves in an attempt to react to a sudden change in stability, and thus their health and safety is more secure. The raised position of the handles on my invention allows proper lifting techniques to be used as well, with force being applied substantially by the users' legs rather than their back.

The design of my invention allows great flexible in what it is used to carry because of its use of flexible strapping to secure to the article being lifted, as well as in providing support for that article. The length of the strapping is variable so objects of almost any size (large or small) as well as varying geometry and varying strength points can be safely and efficiently lifted and carried. The simplest shape my invention can be applied to might be a cube such as a box, container or some pieces of furniture (i.e. chest, mattress, box spring or dresser). These are typically symmetrical, with weight evenly distributed, and whose center of gravity is very near its geometric center. My invention can easily be attached to and later detached from such shapes. Use of my invention to lift and carry this type of article is straight forward and its value in this operation is easy to envision. Other objects may have a geometry that is not nearly so symmetrical, such as a couch or large chair. These may be significantly larger in proportion along one side as compared to another. An example is the back of a couch being higher than any other portion. Another example is a couch whose sides are sloping rather than being vertical. Attachment of my invention to such articles is again enabled because of the use of flexible strapping which will accommodate the differing geometry of the article and yet attach securely to the article.

The same strapping accommodates a variety in geometry of bottom surfaces, such as the location of supporting legs on the bottom of a couch. A fixed design such as is proposed in prior art would be limited in where it could be located along the bottom of the article because of interference with the supporting legs of the couch.

Another set of articles that periodically may need to be lifted and carried are those that vary greatly in the distribution of weight throughout the article. An example is a television. The majority of weight is from the large glass picture tube, the front of which forms the screen that displays the picture. This offsets the weight distribution of the article with a significant bias toward the front of the television. When lifting a television the geometry of the article may force the lifter to apply the lifting force away from the center of gravity of the article. My invention allows secure attachment to such an article because of its use of flexible strapping, and further it allows the safe lifting of such an object because of the separation between the points of lift applied by the user. Thus the lifter is not tasked with applying a lifting force in one place as well as a stabilizing force in another. Both lifting and stabilizing is accomplished through the single application of forces allowed by the design of my invention. Another example of such an object with a center of gravity significantly different than its geometric center is a refrigerator with the mechanical components located towards the back of the unit. Although the geometry is very symmetrical and roughly rectilinear, the distribution of weight is biased significantly towards the back of the object.

Lifting some objects is complicated because of the lack of strength along the outer edges of the object where one might be required to grasp it. My invention solves that problem because of the strapping that provides support along the entire bottom surface of the object. Thus a cardboard box that might otherwise burst open on its bottom seam is securely lifted and moved. Likewise for a large appliance such as a wash machine whose sides are typically made of thin sheet metal. The sides of such an article may not adequately support the lifting, carrying and repositioning of the load during its move. My invention provides support along not only the sides of such an object but also along the bottom, thereby spreading out the lifting and carrying forces and decreasing the likelihood of damage.

Heavy objects or objects of a large and awkward shape that require more than two individuals to lift can be simply accommodated with my invention by additional individuals grasping the supplied handles. Thus it is with ease that even up to 4 individuals can lift and carry an object with my invention.

Further objects and advantages of my invention will become apparent from a consideration of the drawing and ensuing description.

### DRAWING FIGURES

FIG. 1 Preferred Embodiment

### REFERENCE NUMERALS IN DRAWING FIGURES

10 Left Handle Assembly

20 Center Handle Assembly

25 Center Handle Assembly

30 Right Handle Assembly

40 Grip

42 Grip

45 Grip

47 Stabilizing Bar

50 Lift Bar Support

55 Lift Bar Support

60 Lift Bar

50 Stop

75 Stop

90 Strap

95 Strap

100 Strap End

110 Strap

140 Buckle

145 Buckle

160 Strap End

170 Strap End

175 Strap End

180 Lifted Article

300 Buckle

400 Strap

410 Strap

420 Strap

### SUMMARY OF THE INVENTION

A lifting and moving device that easily and securely attaches to the object lifted, regardless of shape or edge geometry, provides for separation of the lifting forces so as to apply a stabilizing force in addition to the required lifting force, and provides for multiple individuals to cooperatively lift an object.

### DESCRIPTION OF INVENTION

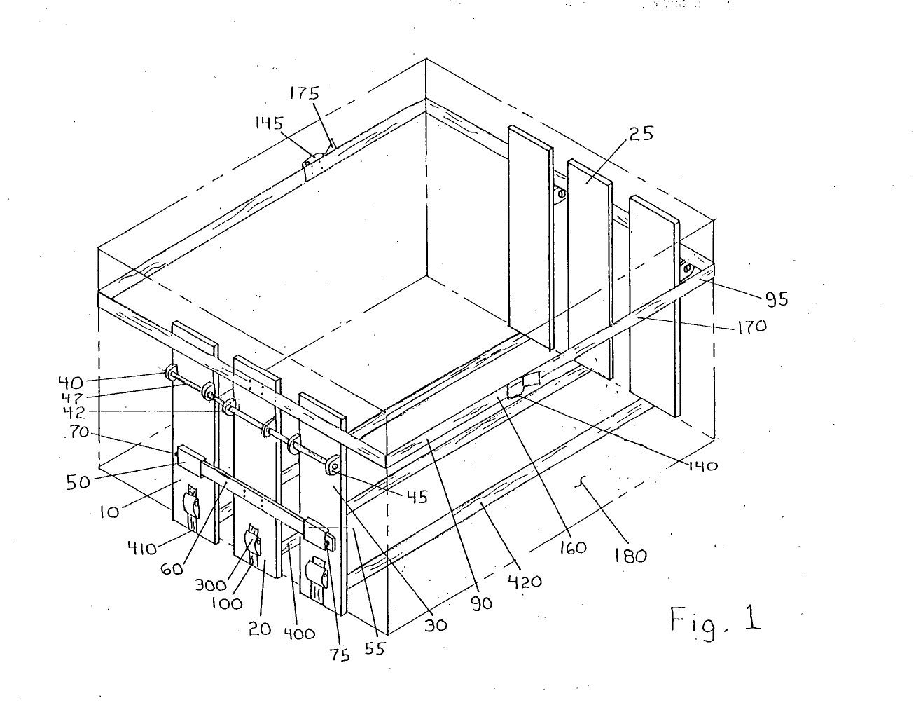

FIG. 1 shows the preferred embodiment of the Lifting and Moving System.

The preferred embodiment of the Lifting and Moving System is comprised of 2 similar handle sets and 4 strap assemblies. It is very sturdy yet lightweight, adding only minimally to the total weight being lifted. The handle sets are placed on opposing sides of the lifted article. The straps attach the handle sets to the lifted article and provide support. The design allows proper lifting technique to be employed—e.g.—the lifter(s) utilizing their legs for the lifting action rather than their back. This design is of particular usefulness in moving heavy and/or bulky items up or down stairs. The design of the handle assemblies permits separation of the areas where lifting forces can be applies, thereby allowing multiple lifters (up to 4 easily) to assist with the effort. This separation also creates a very stable lifting arrangement.

Lift Bar 60 is fastened securely to Center Handle Assembly 20 and in a generally perpendicular orientation to the vertical axis of Center Handle Assembly 20. Lift Bar 60 extends horizontally equally beyond each outer edge of Center Handle Assembly 20 and continues through Lift Bar Support 50 on Left Handle Assembly 10 on one side, and through Lift Bar Support 55 on Right Handle Assembly 30 on the other side.

Lift Bar 60 fits relatively loosely through lift Bar Support 50 and Lift Bar Support 55 so as to allow a sliding action. Stop 70 and Stop 75 are positioned on Lift Bar 60 so as to impede the sliding action of Lift Bar 60 through Lift Bar Support 50 and Lift Bar Support 55.

Grip 40 is fastened securely to Left Handle Assembly 10. Grip 42 is fastened securely to Center Handle Assembly 20. Grip 45 is fastened securely to Right Handle Assembly 30.

A similar set of handle assemblies exists and is positioned at the opposing side of Lifted Article 180. Buckle 140 is securely fastened to Strap End 160 of Strap 90. The approximate center of Strap 90 is fastened securely to Center Handle Assembly 20. Buckle 145 is securely fastened to Strap 95. The approximate center of Strap 95 is fastened securely to Center Handle Assembly 25.

Strap 90 is made to surround Lifted Article 180, with Left Handle Assembly 10, Center Handle Assembly 20 and Right Handle Assembly 30 captured between Strap 90 and Lifted Article 180. Strap 95 surrounds Lifted Article 180 in a similar fashion. Attaching Strap End 175 to Buckle 145, and Strap End 170 to Buckle 140 securely attaches the Lifting and Moving System to Lifted Article 180. One end of Strap 400 attaches to Center Handle Assembly 25. Buckle 300 is attached to Center Handle Assembly 20. Strap End 100 of Strap 400 attaches to Buckle 300. Similarly, Strap 410 and Strap 420 exist and attach to Left Handle Assembly 10 and Right Handle Assembly 30.

### OPERATION OF INVENTION

To operate the Lifting and Moving System, each set of handle assemblies is positioned near opposing ends or sides of Lifted Article 180.

Left Handle Assembly 10 and Right Handle Assembly 30 are positioned along Lift Bar 60 and separated from each other, without going beyond the outer edges of Lifted Article 180.

Strap 400, Strap 410 and Strap 420 are positioned beneath Lifted Article 180. Each of their ends is connected to their respective proximate buckles and each strap pulled tight through the buckles. Strap 90 and Strap 95 horizontally surround Lifted Article 180, connect to their respective buckles and are pulled tight to securely hold Lifted Article 180.

A lifting force may now be applied to Grip 40 and Grip 45, as well as like grips at the opposing end. Lifted Article 180 will now have a lifting force imparted to it through Strap 400, Strap 410 and Strap 420. The distance between Left Handle Assembly 10 and Right Handle Assembly 30 permits a steadying influence to be applied to Lifted Article 180.

### OTHER EMBODIMENTS OF THE INVENTION

Other embodiments of the Lifting and Moving System include but are not limited to:

The lift bar and/or its support can also act as the grip point for the user to apply force.

A single strap can be used to surround the lifted article, one end having a buckle which can be fastened to a handle assembly, the other end being made to pass through a loop on the opposing handle assembly, and continue around the lifted article until it connects to the buckle on the starting end.

Strap 400, Strap 410 and Strap 420 do not have to align perpendicular to any particular handle assembly, but rather can cross over one another if required to more adequately provide support to the lifted article.

For narrow objects, the straps surrounding the lifted article can go directly between each center handle assembly, rather than surround the left or right handle assembly.

There can be additional handle assemblies included in each

### CONCLUSION, RAMIFICATION AND SCOPE OF INVENTION

The reader can deduce from the material herein presented that the invention provides enhancements to prior art in the field of lifting and moving devices. My invention can be applied to objects of varying size, shape, geometry, weight, weight distribution and configuration. The personal safety of the user is increased due to the stabilizing force applied to the load carried because of the separation of lift points provided in my design. Likewise, the likelihood of damage to the article being carried as well as the surrounding areas, individuals and articles is significantly decreased because of the ability to control the load that is offered in my design.

All materials contemplated in the construction of my device are readily obtainable by one versed in the field, and are of reasonable expense. They are common materials that support easy manufacture, manipulation and connection.

Although the description above contains many specifics, these should not be construed as limiting the scope of the invention but as merely providing advantages of some of the presently preferred embodiments of my invention. For instance, other grip points and grip devices can be included in the geometry and design, a single strap can be used to surround the lifted article rather than a series of straps, the straps passing underneath the lifted article and providing vertical support can cross each other, the strap running horizontally around the lifted object can pass directly between the center handle assembles or include any combination of the handle assemblies as required to provide the most complete securement, and the number of handle assemblies per side can vary depending on the intended application.

Accordingly, the scope of the invention should be determined not by the embodiment(s) illustrated or described, but by the appended claims and their legal equivalents.

What is claimed is:

1. A lifting and moving system for attachment to an article subsequently lifted and/or carried, comprising:
a.) a handle assembly and
b.) a handle set made by configuration of multiple said handle assemblies and
c.) an opposing handle set and
d.) a grip securely attached to each said handle assembly in each said handle set and
e.) a stabilizing bar contiguous between each said grip in each said handle assembly and
f.) a lift bar connected to each said handle assembly
g.) a surrounding flexible strap connected to said handle set and
h.) a means to connect said surrounding flexible strap to said surrounding flexible strap from said opposing handle set and
i.) a series of support straps connected at one end to each said handle assembly and
j.) a means to connect the opposite end of said support strap to an opposing said handle assembly
whereby an article of varying characteristics (size, geometry, weight, density, material strength, configuration and distribution of weight) can be lifted by application of forces through separated lift points and carried in a manner that ensures the safety of the user as well as that of the article itself and the surroundings because of the secure attachment to the lifted article and the stabilizing effect of forces being applied at separated points.

2. A lifting and moving system for attachment to an article subsequently lifted and/or carried as claimed in claim 1. where-in said stabilizing bar and said lifting bar are connected to said handle assemblies so as to support a repositioning and linear separation of said handle assemblies along said stabilizing bar and said lifting bar

3. A lifting and moving system for attachment to an article subsequently lifted and/or carried as claimed in claim 1. where-in said grip is an integral feature of said handle assembly by way of a geometric shaping of said handle assembly or a cutout of a portion of said handle assembly.
